(19) United States
(12) Patent Application Publication
(10) Pub. No.: US 2026/0251913 A1
(43) Pub. Date: Aug. 27, 2026

(54) CONTACT LENSES WITH INVERSION MARKS

(71) Applicant: CooperVision International Limited, Fareham (GB)

(72) Inventors: Sanjeev KASTHURIRANGAN, Fremont, CA (US); Lee Anthony HALL, San Ramon, CA (US); Robert CHISHOLM, Amesbury (GB); Gary Colin MILLER, Southampton (GB)

(73) Assignee: CooperVision International Limited, Fareham (GB)

(21) Appl. No.: 19/060,815

(22) Filed: Feb. 24, 2025

Related U.S. Application Data
(60) Provisional application No. 63/559,221, filed on Feb. 29, 2024.

(51) Int. Cl. G02C 7/02; G02C 7/04

(52) U.S. Cl. CPC G02C 7/021; G02C 7/04

(57) ABSTRACT

A contact lens 10 comprising a lens body 12 is disclosed. The lens body 12 comprises an inversion mark 15 defined by a plurality of dimples 50 formed in a surface of the lens body 12; said dimples defining a plurality of symbols. Each symbol of the inversion mark 15 has a symbol height and a symbol width, and for each symbol, the symbol height is greater than twice the symbol width of said symbol.

This application claims the benefit under 35 U.S.C. § 119(e) of prior U.S. Provisional Patent Application No. 63/559,221, filed Feb. 29, 2024, which is incorporated in its entirety by reference herein.

The present disclosure concerns contact lenses. More particularly, but not exclusively, this disclosure concerns contact lenses that have inversion marks and methods of producing contact lenses with inversion marks.

### BACKGROUND

Inversion marks provide a visual indication to a user whether or not a contact lens is inverted prior to insertion of the lens into the eye. A series of dimples in the surface of the lens body can be used to define an inversion mark. Generally, such marks are located as close to the edge of the lens as possible in the belief this can aid visibility because the mark is further from the finger tip when the lens is placed on the finger of a user. However, current inversion marks can still be difficult for a user to see. The presence of the dimples defining the mark may also cause discomfort to a user and/or increase the risk of infection. Accordingly, there remains a need for inversion marks that are easy for a user to see, and/or offer improved comfort and/or reduce infection risk compared to inversion marks on existing contact lenses. Furthermore, there remains a need to provide such inversion marks in contact lenses with various design features and/or within manufacturing constraints.

The present disclosure seeks to mitigate the above-mentioned problems. Alternatively or additionally, the present disclosure seeks to provide improved contact lenses and/or methods of making such lenses.

### SUMMARY

In a first aspect, the present disclosure provides a contact lens comprising a lens body, the lens body comprising; an inversion mark defined by a plurality of dimples formed in a surface of the lens body; said dimples defining a plurality of symbols; and wherein each symbol of the inversion mark has a symbol height and a symbol width, and for each symbol, the symbol height is greater than twice the symbol width of said symbol.

In a second aspect, the present disclosure provides a method of making the contact lens of the first aspect, the method comprising: placing a contact lens formulation onto a concave molding surface of a first contact lens mold member, wherein the concave molding surface includes a molding region that corresponds to the optic zone, peripheral zone, peripheral junction and a plurality of protuberances that correspond to a plurality of dimples defining the inversion mark; placing a second contact lens mold member in contact with the first contact lens mold member to form a contact lens mold assembly; polymerising the contact lens formulation in the contact lens mold assembly to form a polymerised contact lens; removing the polymerised contact lens from the contact lens mold assembly to produce a separated contact lens; and packaging the separated contact lens in a contact lens package.

In a further aspect, there is provided a contact lens blister package comprising the contact lens of the first aspect.

Preferred but optional features are set out in the dependent claims. It will of course be appreciated that features described in relation to one aspect of the present disclosure may be incorporated into other aspects of the present disclosure. For example, the method of the disclosure may incorporate any of the features described with reference to the contact lens of the disclosure and vice versa.

### DESCRIPTION OF THE DRAWINGS

Embodiments of the present disclosure will now be described by way of example only with reference to the accompanying schematic drawings of which:

FIG. 1 is a plan view of a contact lens in accordance with the present disclosure.

FIG. 2 is a section view along line A-A of the contact lens of FIG. 1.

FIG. 3 is a close up view of the inversion mark of the contact lens of FIG. 1.

FIG. 4A is a plan view of dimples forming the inversion mark of the contact lens of FIG. 1.

FIG. 4B is a cross-sectional view of one of the dimples of FIG. 4A.

### DETAILED DESCRIPTION

Example embodiments of the present disclosure will be described below in relation to the accompanying figures.

In a first aspect of the disclosure, there is provided a contact lens comprising a lens body, the lens body comprising an inversion mark defined by a plurality of dimples formed in a surface of the lens body. Said dimples may define a plurality of symbols. Each symbol of the inversion mark has a symbol height and a symbol width. It may be that for each symbol, the symbol height is greater than twice the symbol width of that symbol.

Thus, each symbol of the mark may be taller than it is wide. Surprisingly, this has been found to offer comparable visibility with marks comprising symbols of similar height but having widths similar to their height (e.g. for each symbol the symbol height is roughly equal to the symbol width), while allowing the area occupied by the mark to be reduced. Reducing the area occupied by the mark may reduce the risk of a user experiencing discomfort and/or reduce the risk of infection. Additionally or alternatively, reducing the width of the symbols relative to the height may reduce the number of dimples needed to define the symbol compared with symbols of similar height but having a width roughly equal to their height. This may further reduce the risk of a user experiencing discomfort and/or reduce the risk of infection.

It may be that the contact lens body has a lens edge. It may be that the lens body comprises an optic zone and, optionally, a peripheral zone circumscribing the optic zone. It may be that the lens body comprises a ramp zone circumscribing the peripheral zone, for example extending from the peripheral zone to the lens edge. It may be that the lens body comprises a peripheral junction being the junction between the peripheral zone and the ramp zone. It may be that the peripheral junction is located at least 0.4 mm radially inward from the lens edge. It may be that the radially outermost dimple(s) of the inversion mark are located at least 20 μm radially inward from the peripheral junction.

Contact lenses having a ramp zone in which the thickness of the lens body reduces relatively quickly in the region of the lens edge may offer improved hoop strength in comparison to lenses in which the thickness decreases more gradually over the peripheral zone as a whole. Surprisingly, it has also been found that inversion marks located radially inward of such a ramp zone may be easier for users to see than inversion marks in lenses having a more gradual change in thickness over the peripheral zone.

Unless otherwise specified, distances from the lens edge refer to the radial distance from the lens edge when the lens is viewed in plan view while resting uncompressed on a flat surface with the posterior surface facing down. Likewise, dimensions of the symbols and/or inversion mark refer to the distance when the lens is viewed in plan view while resting uncompressed on a flat surface with the posterior surface facing down.

The lens body may be a polymeric unit that results from polymerisation of a contact lens formulation. The optic zone may have a diameter from 7.5 mm to 9.0 mm inclusive. The diameter is understood to be a chord diameter. The optic zone corresponds to the portion of the contact lens that overlays the pupil of an eye, and the optic zone refracts light in such a way as to provide the desired visual benefit to the person wearing the contact lens. The optic zone may have a corrective refractive power from +20.00 diopters (D) to −20.00 D. The distance corrective refractive power corresponds to the refractive power necessary to correct the person's distance vision. Typically, a border can be visibly discerned at the junction of the optic zone and the peripheral zone. This border may be referred to as the optic zone perimeter.

The lens edge may be defined as the junction of the anterior surface and the posterior surface of the lens body. In the manufacture of contact lenses, it is desirable to control the dimensions of the lens edge. The shape of the lens edge region can influence the comfort of contact lenses. Thus, in the present contact lenses, the lens edge has an edge thickness that may contribute to a comfortable wearing experience for the person. To help ensure desired quality control, the edge thickness is measured at a specified distance from the actual lens edge. Thus, as an example, the present contact lenses may have an edge thickness that is less than 0.10 mm when measured at a radial distance 0.10 mm from the lens edge (i.e., from the lens edge towards the geometric center of the contact lens body). It may be that the lens edge thickness is less than 0.08 mm at a radial distance 0.10 mm from the lens edge. It may be that the lens edge thickness is less than 0.08 mm at a radial distance 0.07 mm from the lens edge. It may be that the lens edge thickness is less than 0.05 mm at a radial distance 0.07 mm from the lens edge.

Typically, a border can be visibly discerned at the junction of the peripheral zone and the ramp zone. This may be referred to as the peripheral junction. In embodiments, the peripheral junction is located from 0.4 mm to 0.9 mm inclusive radially inward from the lens edge, for example from 0.4 mm to 0.6 mm inclusive radially inwards from the lens edge, for example from 0.45 mm to 0.55 mm inclusive radially inwards from the lens edge. In the same or yet further embodiments, the radially outermost dimple(s) of the inversion mark are located at least 20 μm radially inward from the peripheral junction, for example from 20 μm to 80 μm, for example from 20 μm to 60 μm, for example from 20 μm to 40 μm radially inward from the peripheral junction. Positioning the inversion mark closer to the ramp zone than the optic zone may make manufacturing easier and/or improve the visibility of the mark compared to inversion marks positioned immediately adjacent the optic zone.

The curvature of the anterior surface in the ramp zone diverges from the curvature of the anterior surface in the peripheral zone such that the anterior and posterior surfaces of the lens body converge at the lens edge. It may be that, in the ramp zone, the thickness of the lens body varies more rapidly with increasing radial distance than in the peripheral zone. For example, it may be that, along any given radius, the minimum rate of change of thickness with radial distance in the ramp zone is greater than the maximum rate of change of thickness with radial distance in the peripheral zone. For example, it may be that the curvature of the anterior surface is substantially constant along any given radius across the peripheral zone, and the curvature of the anterior surface along said radius continually varies in the ramp zone. It may be that the curvature of the posterior surface continually varies along any given radius in the ramp zone such that the anterior and posterior surfaces of the lens body converge at the lens edge. Alternatively, it may be that the curvature of the posterior surface is substantially constant along any given radius across the majority, for example at least 90 % of the width of the ramp zone.

As used herein, unless otherwise specified, the thickness of the lens body at any given location is the distance from the anterior surface to the posterior surface of the lens body measured normal to the posterior surface at said location. The thickness can be determined using conventional techniques, such as by visually measuring the distance from the anterior surface to the posterior surface on a sectioned lens.

The present contact lenses have a peripheral junction thickness being the thickness at the peripheral junction. The peripheral junction thickness and the center thickness can be important features in the design of the optics of the contact lens. For example, one may set the peripheral junction thickness at a set target value, and set the center thickness at a set target value, and then adjust the curvature of the anterior surface of the contact lens to provide the desired refractive power with those two fixed points. It will be appreciated that the center thickness will vary depending on the corrective optical power of the lens. Embodiments, of the present contact lenses have a center thickness from 0.06 mm to 0.5 mm inclusive and/or a peripheral junction thickness from 0.15 mm to 0.2 mm inclusive. An embodiment may have a center thickness from 0.065 mm to 0.5 mm inclusive, and a peripheral junction thickness of 0.16 mm. An embodiment may have a center thickness from 0.075 mm to 0.3 mm inclusive, and a peripheral junction thickness of 0.16 mm. An embodiment may have a center thickness from 0.07 mm to 0.3 mm inclusive, and a peripheral junction thickness of 0.19 mm. The thickness of the contact lenses may be determined using conventional techniques, as understood by persons skilled in the art. For example, a thickness of the contact lens can be measured mechanically using a gauge, such as a Rehder gauge, or it may be measured optically using an optical measurement system.

It may be that the central zone consists of a single effective refractive power to correct the distance vision of a person. It may be that the refractive power is substantially constant across the entire central zone, including the geometric center of the central zone. In addition, the central zone may have a cylinder correction to correct for astigmatism, or it may have a varying refractive power to help improve vision of presbyopes, or a combination thereof.

The contact lens has an inversion mark. The form of the inversion mark and its location on the lens are configured to provide a different appearance to a user in dependence on whether the lens is inverted or uninverted (when viewed from the same position). The inversion mark is defined by a plurality of dimples formed in a surface, for example the anterior surface, of the lens body. The inversion mark comprises a plurality of symbols, for example a series of symbols, for example a series of letters, or numbers, or both, defined by said dimples. The inversion mark may comprise and/or consist of, three symbols. For example, the inversion mark may be ‘ABC’ or ‘YES’. These may be of particular application as inversion marks as each is a familiar letter series with the necessary (lack of) symmetry to act as an inversion mark. It may be that each symbol of the inversion mark is one of E, Z, V or F. The shape of these letters may be particularly suitable for symbols which have a height greater than twice the width. It may be that each symbol of the inversion mark is a Sloan letter. As the skilled person will appreciate, the Sloan letters are used in Snellen charts and logMAR charts to test visual acuity and are C, D, H, K, N, O, R, S, V and Z. Unless otherwise stated, references herein to the dimensions and/or position of the dimples are references to the dimensions and/or position of the dimples on the hydrated lens.

Each dimple may be a depression or indentation in the anterior surface. Thus, a dimple may be a pit or pocket in the surface of the lens body. Each dimple may comprise a recess defined by an indented portion of the surface. Each dimple may comprise an opening. The edge of the opening may be defined as the location where the curvature of the surface of the lens that defines the recess diverges, for example diverges by at least 1%, for example by at least 5%, from the curvature of the surface of the lens surrounding the dimple. Each dimple may have a substantially circular opening.

Each dimple may have a diameter (a dimple diameter). The diameter may be measured at the opening of the dimple. In the case of a non-circular opening, the diameter may be the greatest distance between opposite sides of the opening. It may be that the average (mean) diameter of the dimples defining the inversion mark (hereafter the dimples) is from 80 μm to 120 μm, for example from 90 μm to 110 μm, for example 100 μm. The diameter of the dimples may be substantially uniform. For example, the diameter of the dimples may have a narrow distribution such that each diameter is within 20%, 15%, 10%, 5% or 1% of the average (mean) diameter of the dimples. For example, each of the dimples may have a diameter that is within 15 μm, for example within 10 μm of the average (mean) diameter of the dimples.

Each dimple may have a depth (a dimple depth). The depth of a dimple may be defined as the maximum vertical distance between (i) a notional plane being a continuation of the curvature of the surface of the lens in the region surrounding the dimple and (ii) the indented surface of the lens that defines the dimple. It may be that the average (mean) depth of the dimples defining the inversion mark (hereafter the dimples) is from 17 μm to 10 μm, for example from 17 μm to 12 μm. The depth of the dimples may be substantially uniform. For example, the depth of the dimples may have a narrow distribution such that each depth is within 20%, 15%, 10%, 5% or 1% of the average (mean) depth of the dimples. For example, each of the dimples may have a depth that is within 2 μm, for example within 1 μm of the average (mean) diameter of the dimples.

It may be that the dimples defining the inversion mark are located radially inward from the peripheral junction. It may be that the dimples defining the inversion mark are formed in a portion of the surface of the lens in the peripheral zone. In embodiments, the radially outermost dimple(s) of the inversion mark are located at least 20 μm, for example at least 40 μm, radially inward from the peripheral junction. The radially outermost dimples of the inversion mark may be located between from 20 μm to 120 μm inclusive, for example from 40 μm to 60 μm inclusive, radially inward from the peripheral junction.

It may be that the radially innermost dimple(s) of the inversion mark are located no more than 260 μm radially inward from the peripheral junction, for example no more than 220 μm radially inward from the peripheral junction. Such a location on the lens may assist in providing a mark that may be more easily perceived by a user and therefore require fewer dimples in order to achieve the necessary level of visibility. As fewer dimples are required, the risk of user experiencing discomfort and/or the risk of infection may be reduced.

It may be that the inversion mark is located in the peripheral zone of the lens and/or between the optic zone and the peripheral junction of the lens.

Each symbol of the inversion mark has a height (the symbol height). The symbol height may be the maximum extent of the symbol in a radial direction (i.e., the radial distance between the radially innermost and radially outermost dimples of the symbol). It may be that each symbol of the inversion mark has a height of between from 1.2 mm to 2.0 mm inclusive, for example from 1.4 mm to 1.8 mm inclusive. Such a symbol height may assist in providing a mark that may be more easily perceived by a user and therefore require fewer dimples in order to achieve the necessary level of visibility.

Each symbol of the inversion mark has a width (the symbol width). The symbol width may be defined as the straight-line distance (in a circumferential as opposed to radial sense) between the circumferentially outermost dimples of the symbol. It may be that each symbol of the inversion mark has a width of between from 0.4 mm to 0.6 mm inclusive.

Each symbol of the inversion mark has an angular extent (the symbol angle). The symbol angle may be defined as the maximum angular extent of the symbol in a circumferential direction (i.e., the angle around the geometric center of the lens between the circumferentially outermost dimples of the symbol). It may be that each symbol of the inversion mark has an angle of between from 7 degrees to 9 degrees inclusive. Such a symbol angle may assist in providing a mark that may be more easily perceived by a user and therefore require fewer dimples in order to achieve the necessary level of visibility.

The inversion mark has a height (the mark height). The mark height may be the maximum extent of the mark in a radial direction (i.e., the radial distance between the radially innermost and radially outermost dimples of the mark). It may be that the inversion mark has a height of between from 1.2 mm to 2.0 mm inclusive, for example from 1.4 mm to 1.8 mm inclusive. Such a mark height may assist in providing a mark that may be more easily perceived by a user and therefore require fewer dimples in order to achieve the necessary level of visibility.

The inversion mark has a width (the mark width). The mark width may be defined as the straight-line distance (in a circumferential as opposed to radial sense) between the circumferentially outermost dimples of the mark. It may be that the mark has a width of between from 1.5 mm to 2.0 mm inclusive.

The inversion mark has an angular extent (the mark angle). The mark angle is defined as the maximum angular extent of the mark in a circumferential direction (i.e., the angle around the geometric center of the lens between the circumferentially outermost dimples of the mark). It may be that the inversion mark has an angle of between from 25 to 35 degrees inclusive, for example from 29 degrees to 31 degrees inclusive. Such a mark angle may assist in providing a mark that may be more easily perceived by a user and therefore require fewer dimples in order to achieve the necessary level of visibility.

It may be that the radially outermost dimple(s) of each symbol of the inversion mark are at substantially the same distance from the lens edge in the radial direction as the radially outermost dimple(s) of every other symbol of the mark. It may be that the radially innermost dimple(s) of each symbol of the inversion mark are at substantially the same distance from the lens edge in the radial direction as the radially innermost dimple(s) of every other symbol of the mark. Thus, the inversion mark may have an arcuate shape. It may be that, when viewed in plan view, a notional line joining the radially outermost dimple(s) of each symbol forms the circumference of a sector of a first circle. It may be that, when viewed in plan view, a notional line joining the radially innermost dimple(s) of each symbol forms the circumference of a second, different, circle. It may be that the second circle is concentric with the first circle. Such an arcuate inversion mark may be more easily perceived by a user and therefore require fewer dimples in order to achieve the necessary level of visibility. As fewer dimples are required, the risk of user discomfort and/or infection may be reduced.

It may be that the spacing between the dimples defining a symbol is irregular, such that the dimples define a curved outline of a symbol and/or the dimples do not form a regular grid pattern. Such irregular spacing may allow the symbols to be defined by fewer dimples in comparison to marks defined by dimples in a grid arrangement, while maintaining similar levels of readability. As fewer dimples are required, the risk of user discomfort and/or infection may be reduced.

It may be that each symbol of the inversion mark is formed of dimples located at the perimeter of the symbol. For example, dimples may only be present at the perimeter of the symbol (e.g. around the exterior edges and interior edges if present). Thus, it may be that every dimple of the mark lies along (and contributes to defining) a notional line defining the outline of a symbol. This may allow the symbols to be defined by fewer dimples in comparison to marks having dimples in the interior of the body of the symbol, thereby reducing the risk of user discomfort and/or infection.

The dimple pitch is the minimum straight-line distance between the edges of two dimples next to each other (adjacent to each other). It may be that the average (mean) pitch of the dimples defining the inversion mark (hereafter the dimples) is at least 30 μm. For example, it may be that the dimple pitch is from 30 μm to 60 μm inclusive, for example 30 μm to 45 μm inclusive. Such relatively low densities of dimples may reduce the risk of discomfort and/or reduce the infection risk, particularly when used in marks where dimples are only present at the perimeter of a symbol.

As used herein, “contact lens” means an ophthalmic lens that can be placed on the eye of a person. It will be appreciated that such a contact lens will provide clinically acceptable on-eye movement and not bind to the eye or eyes of a person. The contact lens may be a corneal lens (e.g. a lens that rests on the cornea of the eye), or a scleral lens (e.g. a lens that rests on the sclera of the eye). The contact lens may be a soft contact lens, such as a silicone-free hydrogel contact lens or a silicone hydrogel contact lens.

The contact lens can comprise, consist essentially of, or consist of a hydrogel material. As one example, the contact lens can comprise, consist essentially of, or consist of a silicone hydrogel material. As another example, the contact lens can comprise, consist essentially of, or consist of a silicone-free hydrogel material. Examples of suitable lens formulations for the contact lens include those having the following United States Adopted Names (USANs): methafilcon A, ocufilcon A, ocufilconB, ocufilcon C, ocufilconD, omafilcon A, omafilcon B, comfilcon A, enfilcon A, stenfilcon A, fanfilcon A, etafilcon A, senofilcon A, senofilcon B, senofilcon C, narafilcon A, narafilcon B, balafilcon A, samfilcon A, lotrafilcon A, to lotrafilcon B, somofilcon A, riofilcon A, delefilcon A, verofilcon A, and the like.

According to a second aspect of the disclosure there is provided a method of manufacturing the contact lenses of the first aspect. Such methods include steps of: placing the contact lens formulation onto a concave molding surface of a first contact lens mold member, wherein the concave molding surface includes a molding region that corresponds to the optic zone, the peripheral zone, the peripheral junction, the ramp zone and comprising a plurality of protuberances that correspond to a plurality of dimples defining the inversion mark; placing a second contact lens mold member in contact with the first contact lens mold member to form a contact lens mold assembly; polymerising the contact lens formulation in the contact lens mold assembly to form a polymerised contact lens; removing the polymerised contact lens from the contact lens mold assembly to produce a separated contact lens; and packaging the separated contact lens in a contact lens package. The contact lens may have any of the features described above with reference to the first aspect and the molding surface may have features corresponding to any of said features. The polymerised lens may also optionally be washed using solvents and/or water to remove unreacted chemical compounds. Such a washing step may, for example, be carried out concurrently with the step of removing the polymerised contact lens from the mold assembly. Alternatively or additionally, the washing step may be carried out on the separated lens subsequent to the removing step.

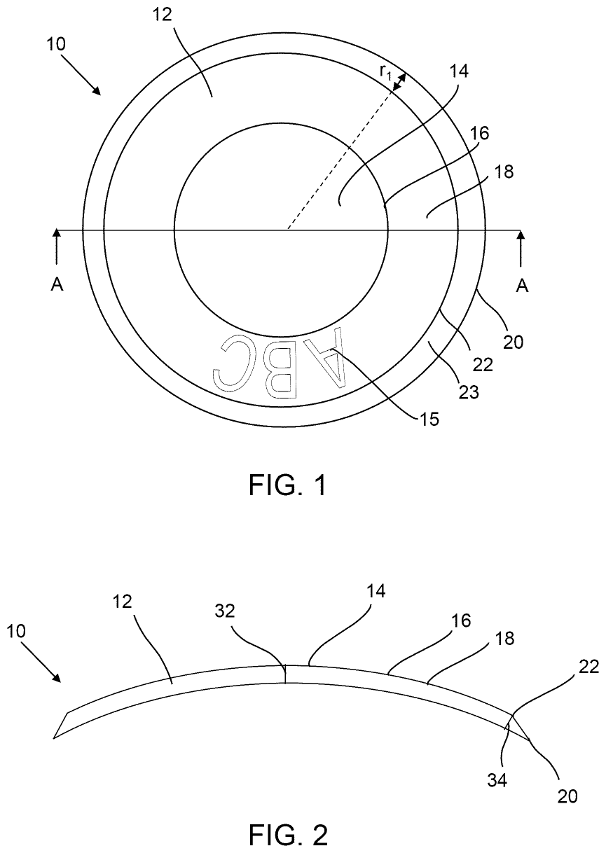

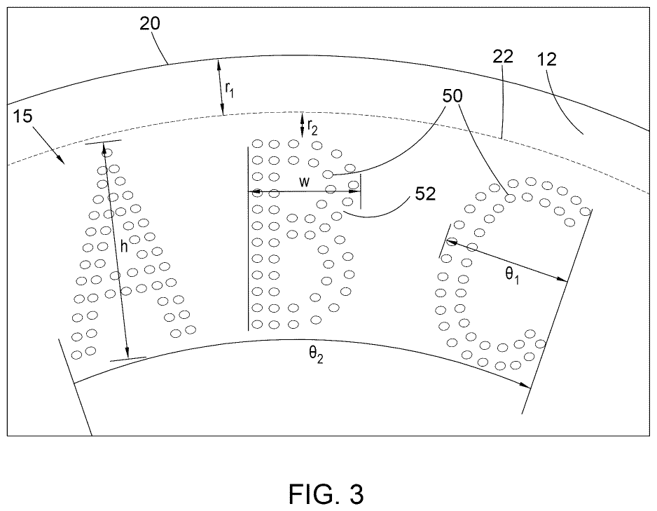

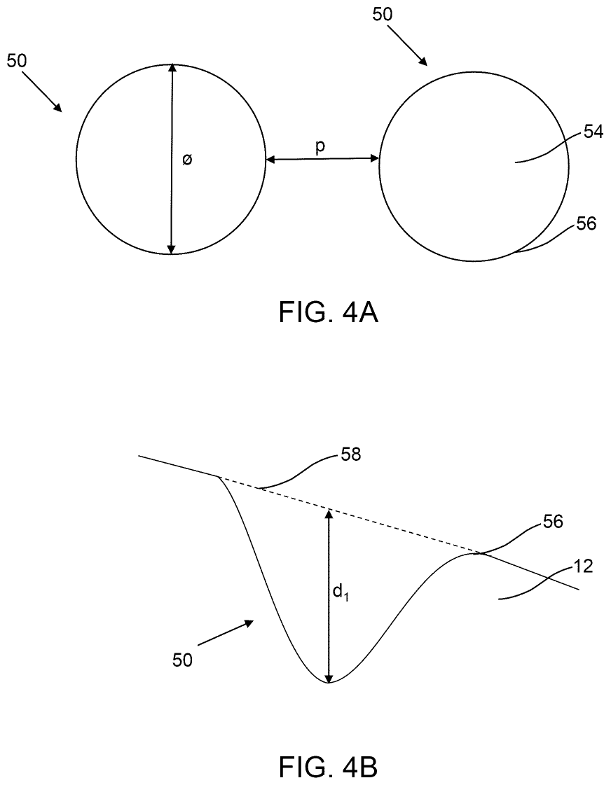

FIG. 1 illustrates a contact lens 10. The contact lens 10 includes a lens body 12. The lens body has an optic zone 14 defined by an optic zone perimeter 16. A peripheral zone 18 circumscribes the optic zone 14 at the optic zone perimeter 16. A lens edge 20 is formed at the junction of the anterior surface and the posterior surface of the lens body. A peripheral junction 22 is illustrated as defining the outer perimeter of the peripheral zone 18 and the inner perimeter of a ramp zone 23. The ramp zone 23 circumscribes the peripheral zone and extends between the peripheral junction 22 and the lens edge 20. An inversion mark 15 in the form of ‘ABC’ is located in the peripheral zone 18. With reference to FIG. 3, inversion mark 15 is formed by a plurality of dimples 50 formed in the anterior surface of the lens body 12 and defining the perimeter of each letter making up the mark. The inversion mark is arcuate, with the innermost dimple(s) of each letter being at a substantially constant distance from the lens edge 20 and the outermost dimple(s) of each letter being at a substantially constant distance from the lens edge 20. The peripheral junction 22 is shown as a dashed line in FIG. 3. In one embodiment, the height h of each letter is 1.6 mm and the width w of each letter is 0.4 mm, or 0.7 mm. In the same or yet further embodiments, the height h of each letter is 1.6 mm, and each letter has a symbol angle θ₁ of between 7 and 9 degrees and the inversion mark has a mark angle θ₂ of 30 degrees. In the same of yet further embodiments, the lens diameter is 14.2 mm, the distance r₁ of the peripheral junction 22 radially inward from the lens edge 20 is 470μm, and the distance r₂ of the radially outermost dimples of each symbol radially inward from the peripheral junction 22 is 40 μm. In another embodiment, the lens diameter is 14.1 mm, r₁ is 500 μm and r₂ is 30 μm. In regions of each letter, for example region 52 of the ‘B’, the spacing between the dimples is irregular such that the dimples define a curved line. With reference to FIG. 4A and FIG. 4B, each dimple 50 comprises an opening 54, having an edge 56 at which the curvature of the surface of the lens defining the dimple 50 diverges from the curvature of the surface of the lens surrounding the dimple. Each dimple 50 has a dimple diameter ø. In the same or further embodiments, the mean dimple diameter is 100 μm. Each dimple 50 has a dimple depth d₁ being the maximum vertical distance between (i) a notional plane 58 (shown as a dashed line in FIG. 4B and being a continuation of the curvature of the surface of the lens in the region surrounding the dimple) and (ii) the indented surface of the lens that defines the dimple. In the same or further embodiments, the mean dimple depth is 12 μm. The dimple pitch p is the minimum distance between the openings of two dimples next to each other. In the same or further embodiments, the dimple pitch is at least 30 μm.

FIG. 2 illustrates the contact lens 10 of FIG. 1 in section view along line A-A, the inversion mark is not shown in FIG. 2, but the center thickness 32 and the peripheral junction thickness 34 are illustrated.

The contact lens 10 is made by placing a volume of the contact lens formulation on a concave molding surface of a female mold half, and placing the convex surface of a male mold half in contact with the exposed volume of contact lens formulation to form a contact lens mold assembly. The female mold half has protuberances corresponding to the dimples of the inversion mark. The contact lens mold assembly is then subjected to heat and/or irradiation, e.g. in an oven, and the contact lens formulation is polymerised using heat and/or ultraviolet light. The polymerised lens is then removed from the mold assembly, and washed using solvents and water to remove unreacted chemical compounds. The washed contact lens then is placed in a contact lens package with a packaging solution and is sealed and sterilized using an autoclave.

The resulting contact lens advantageously has an equilibrium water content from 50-60%, and thus is understood to be a soft hydrogel contact lens. It advantageously has a Young's modulus from about 0.3 MPa to about 0.9 MPa. The contact lens advantageously has an oxygen permeability (Dk) of at least 80 barrers.

Whilst the present disclosure has been described and illustrated with reference to particular embodiments, it will be appreciated by those of ordinary skill in the art that the disclosure lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as preferable, advantageous, convenient or the like are optional and do not limit the scope of the independent claims. Moreover, it is to be understood that such optional integers or features, whilst of possible benefit in some embodiments of the disclosure, may not be desirable, and may therefore be absent, in other embodiments.

1. A contact lens comprising a lens body, the lens body comprising;
an inversion mark defined by a plurality of dimples formed in a surface of the lens body;
said dimples defining a plurality of symbols; and
wherein each symbol of the inversion mark has a symbol height and a symbol width, and for each symbol, the symbol height is greater than twice the symbol width of said symbol.

2. The contact lens of claim 1, the lens body having a lens edge, the lens body comprising;
an optic zone;
a peripheral zone circumscribing the optic zone;
a ramp zone circumscribing the peripheral zone and extending from the peripheral zone to the lens edge;
a peripheral junction being the junction between the peripheral zone and the ramp zone; and
the peripheral junction is located at least 0.4 mm radially inward from the lens edge; and
the dimple(s) of the inversion mark that are radially outermost are located at least 20 μm radially inward from the peripheral junction.

3. The contact lens of claim 2, wherein the curvature of the anterior surface of the lens body in the ramp zone diverges from the curvature of the anterior surface in the peripheral zone, such that the anterior and posterior surfaces of the lens body converge at the lens edge.

4. The contact lens of claim 1, wherein the peripheral junction is from 0.4 mm to 0.9 mm inclusive radially inwards from the lens edge, for example from 0.4 mm to 0.6 mm inclusive radially inwards from the lens edge.

5. The contact lens of claim 1, wherein the peripheral junction has a thickness from 0.15 mm to 0.2 mm inclusive and/or wherein the contact lens has a center thickness from 0.06 mm to 0.5 mm inclusive.

6. The contact lens of claim 1, wherein the lens edge has an edge thickness less than 0.10 mm measured at a radial distance 0.10 mm from the lens edge.

7. The contact lens of claim 6, wherein the lens edge thickness is less than 0.08 mm at a radial distance 0.10 mm from the lens edge.

8. The contact lens of claim 1, wherein the lens edge thickness is less than 0.08 mm at a radial distance 0.07 mm from the lens edge.

9. The contact lens of claim 8, wherein the lens edge thickness is less than 0.05 mm at a radial distance 0.07 mm from the lens edge.

10. The contact lens of claim 1, wherein a mean diameter of the dimples defining the inversion mark is from 80 μm to 120 μm, for example from 90 μm to 110 μm, for example 100 μm.

11. The contact lens of claim 1, wherein a mean depth of the dimples defining the inversion mark is from 17 μm to 10 μm, for example from 17 μm to 12 μm.

12. The contact lens of claim 1, wherein a mean pitch of the dimples defining the inversion mark is at least 30 μm.

13. The contact lens of claim 1, wherein the radially outermost dimple(s) of each symbol are at substantially the same distance from the lens edge in the radial direction as the radially outermost dimple(s) of every other symbol.

14. The contact lens of claim 1, wherein the radially innermost dimple(s) of each symbol are at substantially the same distance from the lens edge in the radial direction as the radially innermost dimple(s) of every other symbol.

15. The contact lens of claim 1, wherein the spacing between the dimples defining a symbol is irregular, such that the dimples define a curved outline of a symbol and/or the dimples do not form a regular grid pattern.

16. The contact lens of claim 1, wherein each symbol of the inversion mark is formed of dimples located at the perimeter of the symbol.

17. The contact lens of claim 1, wherein the dimples are formed in an anterior surface of the lens body.

18. The contact lens of claim 1, wherein the inversion mark comprises three symbols, each symbol being one of E, Z, V or F, or wherein the inversion mark is ‘ABC’ or ‘YES’.

19. A contact lens blister package containing the contact lens in accordance with claim 1.

20. A method of making the contact lens of claim 1, said method comprising:
placing a contact lens formulation onto a concave molding surface of a first contact lens mold member, wherein the concave molding surface includes a molding region that corresponds to the optic zone, peripheral zone, peripheral junction and a plurality of protuberances that correspond to a plurality of dimples defining the inversion mark;
placing a second contact lens mold member in contact with the first contact lens mold member to form a contact lens mold assembly;
polymerising the contact lens formulation in the contact lens mold assembly to form a polymerised contact lens;
removing the polymerised contact lens from the contact lens mold assembly to produce a separated contact lens; and
packaging the separated contact lens in a contact lens package.
